(19) United States
(12) Patent Application Publication
(10) Pub. No.: US 2010/0259408 A1
(43) Pub. Date: Oct. 14, 2010

(54) LUGGAGE LOCATING APPARATUS AND METHODS

(76) Inventor: Patrick A. BERGER, Clackamas, OR (US)

Correspondence Address: Silicon Forest Patent Group;Paul J. Fordenbacher, 11876 NW Tyler Ct, Portland, OR, 97229, US

(21) Appl. No.: 12/740,685

(22) PCT Filed: Oct. 20, 2008
(86) PCT No.: PCT/US08/80568

§ 371 Date: Apr. 29, 2010

Related U.S. Application Data
(60) Provisional application No. 61/001,361, filed on Oct. 31, 2007.

(51) Int. Cl. G08B 5/36

(52) U.S. Cl. 340/815.4

(57) ABSTRACT

In accordance with embodiments presented herein, apparatus are provided that are operable for producing a visual indicator for luggage.

### RELATED APPLICATION

This is a PCT patent application claiming priority to U.S. provisional patent application No. 61/001,361, filed on Oct. 31, 2007, which is in its entirety incorporated herewith by reference.

### FIELD

The embodiments presented herein relate to identification and alert devices, and in particular, to apparatus and methods for alerting a user of the presence of a piece of luggage.

### BACKGROUND

There are several problems associated with traveling with accompanying luggage via some mass transit systems. For example, in the common case of retrieving luggage from a revolving luggage carousel, commuters often must sort through a staggering assortment of similarly-appearing luggage pieces. This inconvenience increases in proportion to the number of commuters and luggage pieces being retrieved. Specifically, it becomes increasingly more difficult to get into position to retrieve luggage and correctly identify a particular piece of luggage. This problem is exasperated by the fact that a commuter has only a very short time to identify and retrieve their luggage before it passes out of reach. In the event the luggage escapes, the commuter is often forced to wait until the luggage completes its journey around the carousel to make another attempt to retrieve the luggage.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a front perspective view of an embodiment of an alert tag;

FIG. 2 is a schematic representation of the alert tag of FIG. 1, in accordance with an implementation;

FIG. 3 is a schematic representation of an embodiment of system electronics;

FIG. 4 is a schematic representation of an embodiment of a controller implemented as a microcontroller comprising a processor, a timer, and memory;

FIG. 5 is a front perspective view of another embodiment of an alert tag;

FIG. 6 is a front view of yet another embodiment of an alert tag;

FIG. 7 is a front view of an alert tag as coupled to a handle of a piece of luggage, in accordance with an implementation;

FIG. 8 is a block diagram of an embodiment of a method of programming an alert tag;

FIG. 9 is a side, partial cut-away view of an embodiment of an alert handle; and

FIG. 10 is a perspective view of an embodiment of an alert handle as coupled to a piece of luggage, in accordance with an implementation.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

Reference is made throughout this specification to a “timer” and “counter”, used interchangeably herein. Hereinafter, “timer” and “counter” refer to an electrical, mechanical, and/or software implementation that provides a signal after a predetermined period of time or count. Various modes of time-keeping or counting may be implemented, such as, but not limited to, standard clock functions, counting up to a value, and counting down from a value. An example of an electrical device operable to provide a signal after a predetermined time or count is known as a CMOS 4060 integrated circuit. The CMOS 4060 is a 14-bit binary counter with a built in oscillator. Adjusting the frequency of the oscillator adjusts the frequency of the counting and thus, the length of time it takes for an output on the CMOS 4060 to go high, that is, produce a signal. An output of the CMOS 4060 may be made to produce a signal after being activated for a predetermined number of counts or period of time. This is merely an example and the claimed subject matter is not limited thereto.

Reference is made throughout this specification to a “microcontroller”. Hereinafter, “microcontroller” refers to a single integrated device that may have processor, memory, clock, and input/output functions. A microcontroller may be used in implementations of embodiments herein described. An example of a microcontroller is the MSP430 series microcontroller, Texas Instruments, Dallas, Tex. The MSP430 series microcontroller comprises a 16-bit RISC CPU, memory, and a 16-bit timer. The memory may be used to provide an instruction set to the CPU, and to store software implementations of electronic functions, such as a counter and/or timer. The MSP430 integrates into one device that which may otherwise require many discrete devices. This is merely an example and the claimed subject matter is not limited thereto.

In accordance with embodiments, an alert tag is provided that illuminates at a predetermined time so as to provide the user with a visual alert for the purpose of locating an object to which it is attached. The alert tag comprises a timer and a light source, the timer operable to illuminate the light source at a predetermined time. The alert tag is particularly durable to withstand environmental considerations related to baggage handling such as might be encountered at airport, bus, train, and boat baggage handling situations. The alert tag is provided with means to set a desired time for when the alert tag is to illuminate, such as, for example, the expected time of arrival of a piece of luggage at a luggage carrousel. The illumination produces a visible indication that is automatically activated and operable to signal an owner as to the location of the object to which it is attached.

In accordance with other embodiments, an alert handle is provided that provides the visual functionality of the alert tag described herein but is contained in a handle of a piece of luggage that the handle is attached.

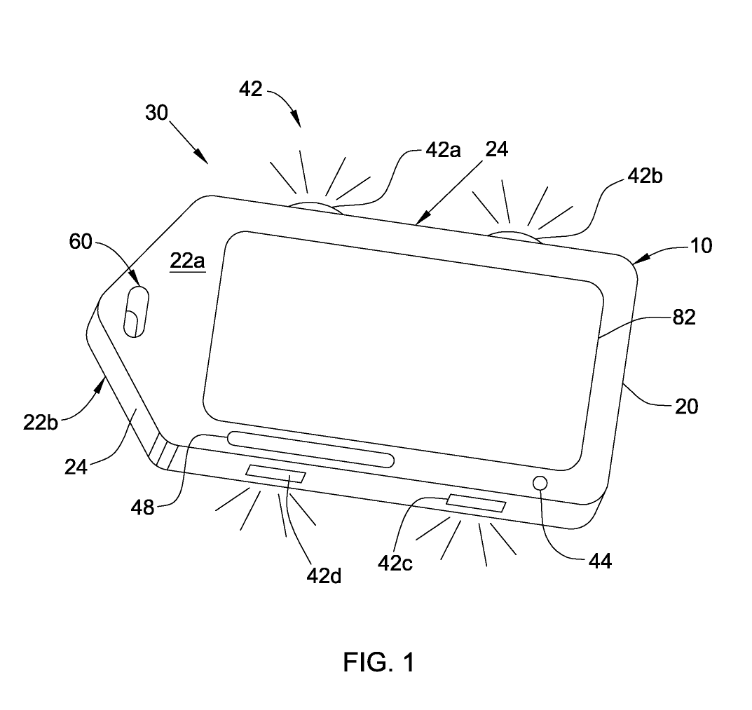

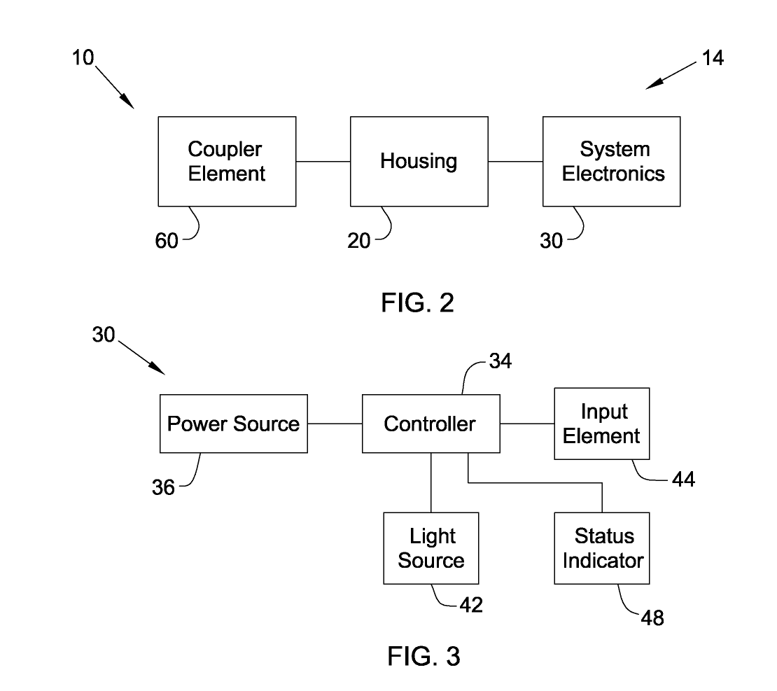

FIG. 1 is a front perspective view of an embodiment of an alert tag 10. FIG. 2 is a schematic representation of the alert tag 10 of FIG. 1, in accordance with an implementation. The alert tag 10 comprises a housing 20, system electronics 30, and a coupler element 60. The system electronics 30 is operable to illuminate a light source 42 at a predetermined user-settable time so as to provide a user with a visual alert at that predetermined time. The housing 20 is operable to house and support the system electronics 30. The coupler element 60 is operable to provide a means to facilitate coupling the housing 20 to an object.

It is understood that the housing 20, system electronics 30, and coupler element 60 may be implemented in many forms suitable for a particular purpose. Referring again to the embodiment of FIG. 1, the housing 20 is implemented in a relatively flat form, that is, a form of a standard luggage identification tag of the type where a business card or the like is inserted behind a window 82 so as to identify the luggage as belonging to the user. It is understood that this is but one example of an implementation of the housing 20 and not limited thereto.

The coupler element 60 is implemented as an aperture operable to receive a strap or the like to assist in the coupling of the alert tag 10 to an object. It is understood that this is but one example of an implementation of the coupler element 60 and not limited thereto.

FIG. 3 is a schematic representation of an embodiment of the system electronics 30. The system electronics 30 comprises a controller 34, input element 44, power source 36, status indicator 48, and light source 42. The controller 34 is in electrical communication with the light source 42 and is operable to activate (illuminate) and deactivate (extinguish) the light source 42 in accordance with data and/or programming. The input element 44 is in electrical communication with the controller 34 and is operable as a means of inputting data and/or programming the controller 34. The status indicator 48 is in electrical communication with the controller 34 and is operable to provide a user with a visual indication of the status of the controller 34. As will be described below, the light source 42 may be implemented to also provide status indicator functionality wherein a separate status indicator 48 may not be necessary.

The power source 36 is in electrical communication with and provides a voltage source to the controller 34, input element 44, status indicator 48, and light source 42. The power source 36 may be in the form of an internal battery. However, any known power source may be used which is suitable for the particular purpose. An example of a suitable power source includes, but is not limited to, a lithium battery such as those commonly used to power a watch or hearing aid.

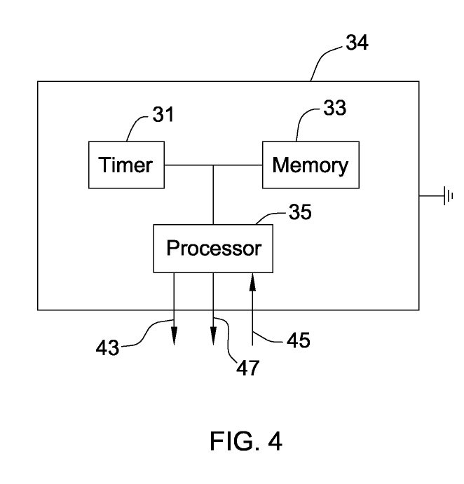

The controller 34 may be any means for accepting a user input and operable for controlling the light source 42 and the status indicator 48 in a predetermined manner. FIG. 4 is a schematic representation of an embodiment of a controller 34 implemented as a microcontroller comprising a processor 35, a timer 31, and memory 33. It is understood that a microcontroller is but only one implementation of the controller 34 and that the functionality of the controller 34 may be implemented in discrete and/or integrated elements, in hardware and/or software implementations.

Referring to FIGS. 1, 3, and 4, the processor 35 includes an input 45 in electrical communication with the input element 44, a first output 43 in electrical communication with the light source 42, and a second output 47 in electrical communication with the status indicator 48. The processor 35 is in electrical communication with a timer 31 and memory 33. By way of example, but not limited thereto, the memory 33 may include one or more random access memory (RAM) devices for providing storage of data, such as, but not limited to, programming, set time, and/or lighting settings.

In accordance with an embodiment, the timer 31 is operable for starting timekeeping in response to a user operation and stopping timekeeping in response to a predetermined set time. The controller 34 is programmed with a predetermined set time by a user via the input element 44. The controller 34 is in electrical communication with the light source 42 such that at the predetermined set time, the controller 34 will be caused to activate the light source 42.

Referring again to FIGS. 1, 3, and 4, input element 44 may be any means suitable for a user to program the controller 34. For example, but not limited thereto, input element 44 may be a contact switch operated by a push button, such as, but not limited to, a button switch and a sealed membrane keypad.

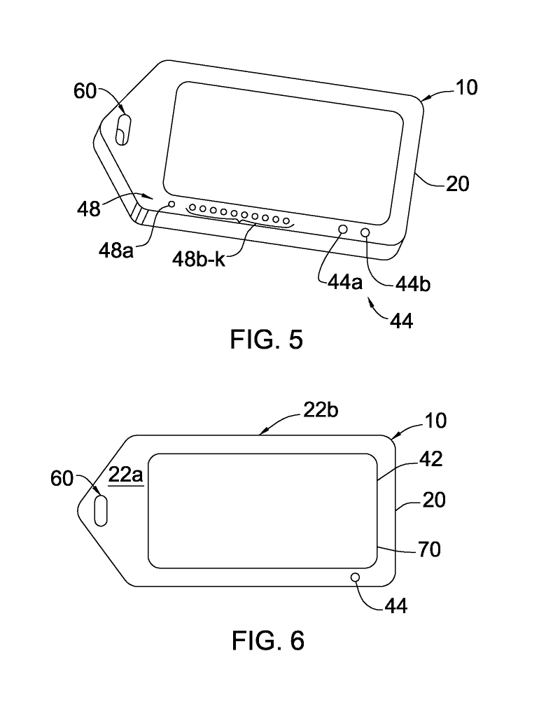

It is understood that input element 44 may be one or more elements. By way of example, in an embodiment of the alert tag 10 shown in FIG. 5, input element 44 comprises a first button 44a and a second button 44b. In an example implementation, first button 44a may be used to increment the timer 31, shown in FIG. 4, by time increments of 15 minutes, and second button 44b may be used to increment the timer 31 by time increments of 1 hour.

The user may increment the timer 31 to a set time; that is, the time in which the user desires the controller 34 to activate the light source 42. For example, the user may input a set time that corresponds to an anticipated time of arrival of the luggage to the pickup point to which the alert tag 10 is attached. For example, if the user expects the luggage to be at the baggage pickup point in 3.5 hours, the user may press the first button 44a twice for one-half hour and may press second button 44b three times for 3 hours for a total of 3.5 hours. The light source 42 will then be caused to activate 3.5 hours after the set time was programmed and the timer 31 initiated to count down the time.

It is understood that button presses and combinations of button presses may be used to program the controller 34. For example, but not limited thereto, a combination of button presses may be used to turn the controller 34 on and off, to reset the timer values, to program the controller 34 to illuminate the light source 42 in a particular color, duration, blink rate, and/or combination thereof, but not limited thereto.

It is also understood that programming the controller 34 may be implemented in many ways. For example, but not limited thereto, the set time may be entered into the controller 34 by using an input element 44 that is operable to increment and/or decrement time values for each of a plurality of digit positions on a status indicator 48 implemented as an alpha/numeric display. In another example, a SET and ENTER function assigned to a button(s) or button sequence, for example, may provide access to one or more preprogrammed set times. Other button(s) or button sequences may be used for other programmable software and/or hardware functions provided by controller 34.

Other programming and control functions may be accessed via the input element 44 that are implemented in embodiments of the alert tag 10. For example, but not limited thereto, the input element 44 may be used to illuminate the status indicator 48 and program the blink rate (illumination on/off) for the light source 42. The software programming functions may be indicated by prompts on the status indicator 48 that is implemented in the form of an alpha-numeric display to help the user program functions without the need for written instructions.

Referring again to FIGS. 1, 3-5, the status indicator 48 is operable to provide a user with a visual indication of the status of the controller 34. The status of the controller 34 may include, but is not limited to, the set time, the remaining time to activation, power status, and/or programmed functions. Programmed functions may include, but not limited to, control of the light source 42, such as, but not limited to, duration of the illumination, color, pattern or sequence of illumination of a plurality of light sources 42, and other attributes.

The status indicator 48 may be implemented in any means for providing such indication. Examples of status indicators suitable for the particular purpose include, but not limited to, one or more light emitting diodes (LED) and an alpha-numeric liquid crystal display (LCD).

The status indicator 48 is operable to provide a visual indicator of the status of the controller 34. Referring to the embodiment of FIG. 5, by way of example, status indicator 48 comprises a plurality of status elements 48a-k as light emitting diodes (LED). Status element 48a indicates one to three 15 minute time increments, wherein the controller 34 is programmed to control the status element 48a to blink once for 15 minutes, twice for 30 minutes, and three times for 45 minutes. Further, the controller 34 is programmed to illuminate status element 48b to indicate one hour, status element 48c to indicate two hours and so on. The illumination of status element 48k indicates ten hours and in combination with status element 48b indicates 11 hours, and so forth. As the timer counts down, each of the corresponding status elements 48a-k extinguishes so as to indicate the remaining time before the controller 34 activates the light source 42 to alert the user. It is anticipated that various combinations of illumination of the status elements 48a-k may be used to provide information to the user.

In accordance with an embodiment, the status elements 48a-k comprise relatively small LED's so as to be relatively discrete, as the alert tag 10 will be in close proximity to the user during the setting/programming process. This is contrasted with a relatively bright illumination put off by relatively large LEDs of the light source 42, in an embodiment, to alert the user from a distance. As stated previously, the light source 42 may be used individually and in place of, or in combination with, the status indicator 48 to provide status information to the user.

The light source 42 may be any apparatus operable to produce light, including combinations of elements operable to produce and transmit light. By way of examples of apparatus suitable as a light source 42, but not limited thereto, include one or more incandescent light bulbs, light-emitting diodes (LED), powder phosphor-based electroluminescent panel, thin film phosphor electroluminescent panel, and other solid-state and non-solid state light sources. However, these are merely examples of apparatus suitable for use as a light source 42 that may be suitable for the particular purpose and claimed subject matter is not limited in these respects.

The light source 42 may further include associated optical components suitable to control the light output in a predetermined manner. Examples of optical components include, but are not limited to, light diffusers, light pipes, fiber optics, and lenses, among others. By way of example, light source 42 may comprise a diffuser operable to diffuse the light so as to spread the light over a larger area than would otherwise be achieved. By way of another example, light source 42 may comprise a lens operable to focus the illumination so as to provide a bright point source of light than would otherwise be achieved. Further, light source 42 may also comprise optical components that impart a color to the light, such as, but not limited to, a translucent window that has a predetermined color.

In yet other embodiments, light source 42 may be operable to provide light in one or more colors. In accordance with an embodiment, the light source 42 comprises an LED having red, green and blue elements so as to produce light in one of 256 colors, for example, but not limited thereto.

In accordance with an embodiment, alert tag 10 comprises a plurality of light sources 42 each of which provide light in one or more colors. In an embodiment, the controller 34 is operable to allow a user to select one or a combination of light sources 42 to be activated, in combination or in sequence, so as to illuminate the light sources 42 in one or more colors.

In another embodiment, controller 34 may be operable to activate a particular light source 42 having a capability of producing light in more than one color. Light source 42 may be operable to allow a user to select a particular color or a combination of colors in a particular sequence.

In another embodiment, as shown in FIG. 1, alert tag 10 comprises multiple light sources 42a-d. In a particular implementation, the controller 34 is operable to control the light sources 42a-d to blink in a predetermined pattern. In an embodiment, the light source 42 is controlled wherein the controller 34 is programmed to illuminate the multiple light sources 42a-d so as to provide illumination that “races” around the peripheral edge 24. In yet another embodiment, the light source 42 is operable to change the color of the illumination in a predetermined pattern. In various embodiments, the output of the illumination may be permanently set by the manufacturer or programmable/selectable by the user.

In another embodiment, the controller 34 may be implemented with functionality beyond simply illuminating the light source 42 after a preset time has expired. For example, in an embodiment, the controller 34 is programmed such that the light source 42 may be caused to blink when activated. In accordance with an implementation, controller 34 may be programmed to activate light source 42 for a time duration Δt.sub.on wherein the light source 42 illuminates, and deactivate light source 42 for a time duration Δt.sub.off wherein the light source 42 is extinguished. In an embodiment, by way of example, the duration Δt.sub.on is 0.25 seconds and Δt.sub.off is 1 second. However, the duration and frequency at which the light source 42 is activated may be other values and not limited thereto.

In further embodiments, the controller 34 may be programmed for energy saving operation. By way of example, after the alert tag 10 has produced a visible alert (illumination) for a period of time, for example 15 minutes, the controller 34 will enter a sleep mode for a predetermined time, for example 30 minutes, and alert (illuminate) again for 15 minutes, and so forth until deactivated by the user or after a predetermined time. This may save battery energy in those cases where the luggage is delayed in transit to the luggage pickup point and the alert (illumination) is needed at a time after the set time.

FIG. 6 is a top view of an embodiment of the alert tag 10 wherein the light source 42 is in the form of an electroluminescent panel 70. The panel 70 may comprise the majority of a first broad surface 22a of the housing 20. The panel 70 may also be placed on a second broad surface 22b opposite to the first broad surface 22a of the housing 20. Thus, the light source 42 may be viewable from either side of alert tag 10 and thereby allowing the light source 42 to be viewed regardless of the side on which alert tag 10 may be resting.

In accordance with embodiments of the alert tag 10, the alert tag 10 comprises a coupler element 60 adapted for coupling the housing 20 to an object. In an implementation, the coupling element 60 is suitable for accepting a split-ring operable so as to allow the alert tag 10 to be attached to an item suitable therefore, such as a zipper handle that has an aperture therein, for example. In an embodiment, the coupling element 60 is an aperture suitable for accepting a strap therethrough, such that alert tag 10 may be removably coupled to an object by the strap having ends coupled by, for example, but not limited to, a buckle or hook and loop type fasteners. However, these are only examples of coupling elements 60 that may be suitable for the particular purpose and claimed subject matter is not limited in these respects.

As shown in the perspective view of the alert tag 10 of FIG. 1, the alert tag 10 may be of a relatively flat and thin configuration having first and second broad surfaces 22a,22b defining a peripheral edge 24, much like that of a common luggage identification tag that couples to a handle of luggage. In accordance with embodiments, the light source 42 is operable to illuminate at least a portion of the peripheral edge 24 and/or illuminate at least one of the first and second broad surfaces 22a,22b of the alert tag 10.

In accordance with an embodiment, the housing 20 further includes capability to accept identification information concerning the owner of the piece of luggage, much as a standard luggage tag. By way of example, in the embodiment of FIG. 1, the alert tag 10 is operable to accept a business card or the like inserted behind a window 82 so as to identify the luggage as belonging to the user.

In an embodiment, the housing 20 may be made of metal, plastic, leather, or any other suitable material and combinations thereof. In another embodiment, the housing 20 further comprises a cover (not shown). The cover may be slidingly and/or hingeably engaged with the housing 20 so as to protect one or more of the input element 44, status indicator 48, and the window 82.

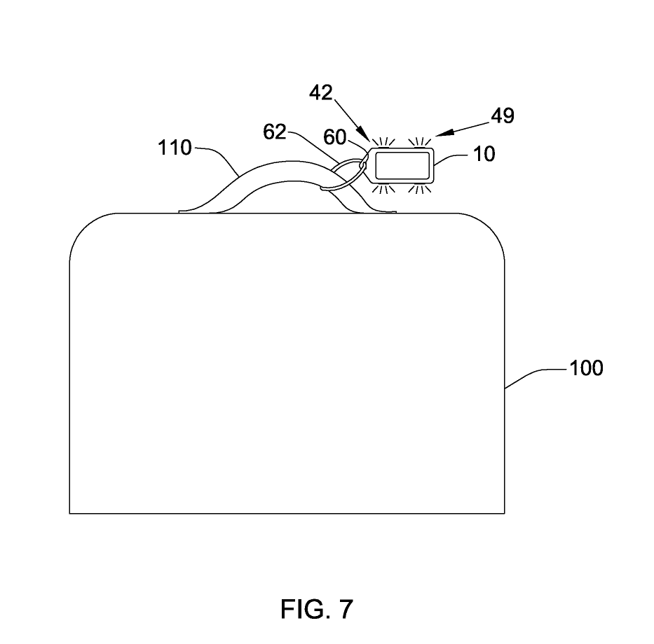

FIG. 7 is a front view of an embodiment of an alert tag 10 as coupled to a handle 110 of a piece of luggage 100, in accordance with an implementation of a method of using the alert tag 10. The alert tag 10 is operable to generate a visual indication 49, also referred herein as a visible alarm or illumination. The visual indication 49 is operable to assist an owner in locating the piece of luggage 100 such as at a baggage carousel of an airport terminal. The visual indication 49 is indicated by the diagonal lines shown emanating from the alert tag 10. The visual indication 49 is automatically activated and operable to signal an owner as to the location of the luggage 100 to which it is attached. The visual indication 49 of the alert tag 10 may be useful for locating objects in any area, such as airline terminals, passenger ship terminals, and other similar environments. The visual indication 49 of the alert tag 10 may also be useful in locating a misplaced piece of luggage 100 to which the device is attached.

The alert tag 10 is operable to generate a visual indication 49 at a predetermined set time. A user may program the controller 34, as shown in FIG. 4, to set the timer 31 to a predetermined set time for activating the light source 42 so as to produce a visual indication 49. Upon the timer 31 reaching the set time, the alert tag 10 generates a visual indication 49. The visual indication 49 aids the user in locating the piece of luggage 100.

The user may look around the baggage area for a visual indication 49 in the form of a distinct pattern and/or color of light emitting from the alert tag 10. The user may then be able to identify the location of the piece of luggage 100 by identifying the visual indication 49. The visual indication 49 may be operable to be seen from a predetermined range, such as, but not limited to, 30 feet, from alert tag 10 as located in a well lit environment.

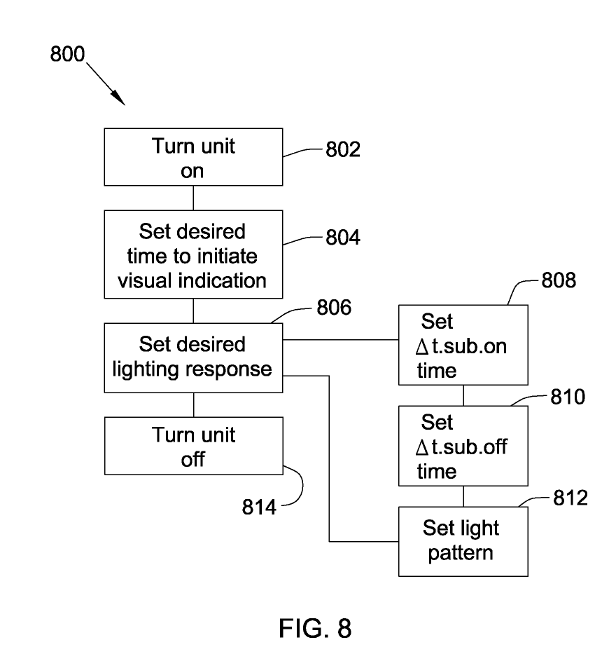

FIG. 8 is a block diagram of an embodiment of a method 800 of programming the alert tag. The user turns the system electronics on by activating an input element 802. The user inputs a set time to for the alert tag to initiate a visual indication by programming the controller to set the timer to a time substantially that associated with the expected time of pickup of the luggage at a destination 804. The user programs the controller to a desired lighting response 806, including a delta-t on time 808, a delta-t off time 810, and the user may set a light pattern 812. The user may turn the system electronics off when no longer needed 814.

By way of example, the use of the alert tag 10 will now be described with reference to FIGS. 1-7. A coupler 62, such as, but not limited to, a strap, is provided through the coupler element 60 and coupled to a handle 110 of a piece of luggage 100. The alert tag 10 is programmed with the desired set time; that is, the time in which the controller 34 is programmed to activate the light source 42. For example, if the user expects to be at a destination to pick up the luggage 100 in two and a half hours, the user programs the alert tag 10 to activate the light source 42 in two and a half hours such that alert tag 10 will have been caused to display a visual indication 49 at the desired time.

Once the user programs the alert tag 10 to the desired set time and initiates the timer, the owner of the luggage 100 may release the luggage 100 for travel, e.g. to a baggage handler or ticket agent, so that the luggage 100 may be stowed for travel, e.g. such as in a baggage compartment. Upon completing travel, the luggage 100 may be transported to a central baggage pick up area where the owner may reclaim the luggage 100. If the set time has elapsed, the light source 42 of alert tag 10 will illuminate so as to provide a visual indication 49 to assist the user in finding the luggage 100. The visual indication 49 will assist the user in drawing attention to their own luggage and identify their luggage 100 from those pieces of luggage that may look similar. Upon reaching the luggage 100, the user deactivates the alert tag 10 and thus turns off the visual indication 49.

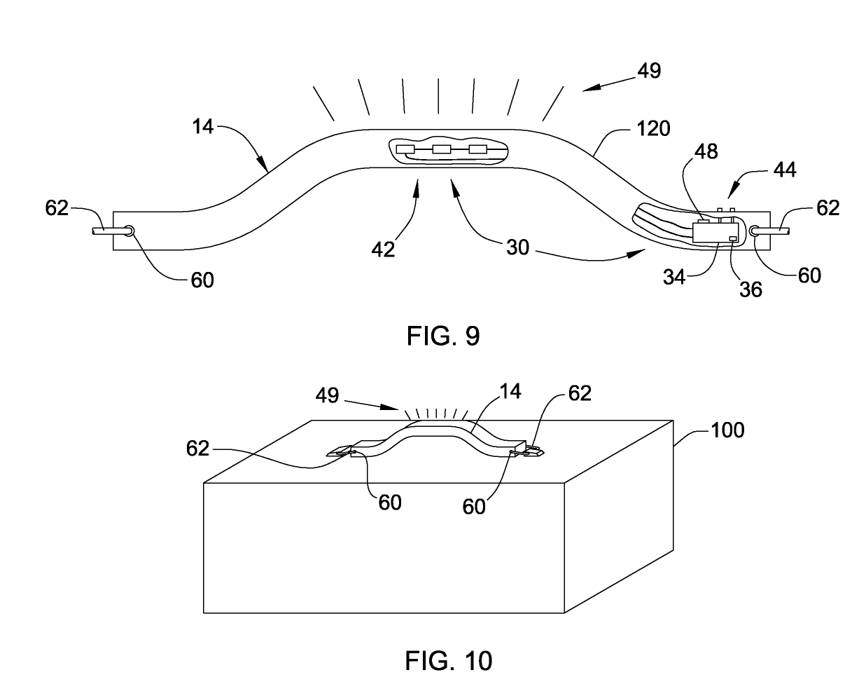

FIG. 9 is a side, partial cut-away view of an embodiment of an alert handle 14 comprising a housing 120, system electronics 30, and a coupler element 60. FIG. 10 is a perspective view of an alert handle 14 as coupled to a piece of luggage 100, in accordance with an embodiment. The alert handle 14 is substantially similar in function as the embodiment of the alert tag 10 represented schematically in FIG. 2, wherein the housing 120, rather than being in the form of a luggage tag, is in the form of a handle of a piece of luggage 100.

Similarly, the system electronics 30 is operable to illuminate a light source 42 at a predetermined user-settable time so as to provide a user with a visual alert or indication at that predetermined time. The housing 120 is operable to house and support the system electronics 30. The coupler elements 60 are operable to provide a means for coupling the housing 120 to the luggage 100.

The light source 42 may be implemented in many ways. By way of example, at least a portion of the housing 120 comprises a translucent material and the light source 42 includes one or more light emitting diodes operable to affect illumination through the translucent material so as to be seen external to the housing 120 by the user. Wherein a user will look for illumination emanating from the alert tag 10 of the embodiment of FIG. 1, with the embodiment of FIG. 9, the user will look for the illumination emanating from the alert handle 14.

The coupler element 60 is implemented as an aperture operable to receive a coupler 62, such as, but not limited to, a D-ring or the like, provided through the coupler element 60 to assist in the coupling of the alert handle 14 to the luggage 100. It is understood that this is but one example of an implementation of the coupler element 60, for which many are known to those skilled in the art, and not limited thereto.

The alert handle 14 further comprises an input element 44 operable for a user to program the controller 34 of the system electronics 30 substantially similar to that provided for alert tag 10 of FIG. 1. A status indicator 48 is included to provide visual feedback to the user of the status of the controller 34.

The alert handle 14 further includes a power source 36, such as, but not limited to a battery, as described for the alert tag 10 of FIG. 1.

The elements and functionality of the alert handle 14 may be implemented in substantially the same way as the alert tag 10 of FIGS. 1-5, and therefore the details of which will not be repeated here.

It is anticipated that the alert handle 14 may be provided to a user as a handle replacement for pre-existing luggage and/or provided to a luggage manufacturer for incorporation in a line of luggage.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A luggage tag comprising a timer and a light source, the timer operable to illuminate the light source at a predetermined time.

2. The luggage tag of claim 1, further comprising:
a housing including a coupler element, wherein the coupler element is operable for coupling the housing to a piece of luggage; and
system electronics coupled to the housing, the system electronics comprising:
a power source;
a controller including the timer;
an input element;
the light source; and
a status indicator, wherein the input element is in electrical communication with the controller and is operable for programming the controller, the status indicator is in electrical communication with the controller and is operable to provide a user with a visual indication of the status of the controller, the controller is in electrical communication with the light source and is operable to activate and deactivate the light source in accordance with data and/or programming, and the power source is in electrical communication with and provides a voltage source to the controller, input element, status indicator, and light source,
wherein the controller is operable to control the timer for starting timekeeping in response to input element operation and stopping timekeeping in response to a predetermined set time, and
wherein the light source is illuminated when the timer reaches the set time, the light source operable such that the illumination is visible from outside of the housing.

3. The luggage tag of claim 2, wherein the controller further comprises:
a memory operable to store data and/or programming for the operation of the controller.

4. The luggage tag of claim 2, wherein the timer is operable to keep time by counting up.

5. The luggage tag of claim 2, wherein the timer is operable to keep time by counting down.

6. The luggage tag of claim 2, wherein the input element comprises one or more button switches operable for programming the controller by a user, the input element is operable from outside of the housing.

7. The luggage tag of claim 2, wherein the controller is operable for incrementing the timer in a predetermined time increment in response to operation of the input element by a user.

8. The luggage tag of claim 2, wherein the input element comprises a plurality of buttons, each button being operable for incrementing the timer in a predetermined time increment by a user, each button operable from outside of the housing.

9. The luggage tag of claim 2, wherein the input element comprises:
a first button operable for incrementing the timer in one hour increments; and
a second button operable for incrementing the timer in one minute increments, each first and second buttons operable from outside of the housing.

10. The luggage tag of claim 2, wherein the input element comprises:
a first button operable for incrementing the timer in one hour increments; and
a second button operable for incrementing the timer in 15 minute increments, each first and second buttons operable from outside of the housing.

11. The luggage tag of claim 2, wherein the coupler is adapted to accept an element suitable for coupling the housing to a piece of luggage.

12. The luggage tag of claim 2, wherein the housing includes a peripheral edge, the light source comprising one or more light emitting diodes arranged about the peripheral edge.

13. The luggage tag of claim 2, wherein the housing includes a first broad surface and a second broad surface opposite the first broad surface, the light source comprising one or more electroluminescent panels arranged about the first and/or second broad surfaces.

14. The luggage tag of claim 2, wherein the controller is operable to receive user data so as to produce a predetermined pattern of illumination if activated.

15. The luggage tag of claim 2, wherein the light unit is operable to receive user data so as to produce light of a predetermined color if activated.

16. The luggage tag of claim 2, wherein the housing comprises a first broad surface and a second broad surface opposite the first broad surface defining a peripheral edge, wherein the light source is operable to illuminate at least a portion of the peripheral edge and/or at least one of the first and second broad surfaces.

17. The luggage tag of claim 16, wherein the housing further comprises a card receiving member adapted to receive an identification card or the like.

18. The luggage tag of claim 2, wherein at least a portion of the housing comprises translucent material, the light source including one or more light emitting diodes operable to affect illumination through the translucent material so as to be seen external to the housing.

19. An apparatus comprising:
a housing including a coupler element, wherein the coupler element is operable for coupling the housing to an object; and
system electronics coupled to the housing, the system electronics including:
a power source;
a controller;
an input element;
a light source; and
a status indicator, wherein the input element is in electrical communication with the controller and is operable for inputting data or programming the controller, the status indicator is in electrical communication with the controller and is operable to provide a user with a visual indication of the status of the controller, the controller is in electrical communication with the light source and is operable to activate and deactivate the light source in accordance with data and/or programming, and the power source is in electrical communication with and provides a voltage source to the controller, input element, status indicator, and light source,
wherein the controller includes a timer operable for starting timekeeping in response to input element operation and stopping timekeeping in response to a predetermined set time, and
wherein the light source is illuminated when the timer reaches the set time, the light source operable such that the illumination is visible from outside of the housing.

20. The apparatus of claim 19, wherein the controller further comprises:
a memory operable to store data and/or programming for the operation of the controller.

21. The apparatus of claim 19, wherein the timer is operable to keep time by counting up.

22. The apparatus of claim 19, wherein the timer is operable to keep time by counting down.

23. The apparatus of claim 19, wherein the input element comprises one or more button switches operable for inputting data by a user, the data input element operable from outside of the housing.

24. The apparatus of claim 19, wherein the controller is operable for incrementing the timer in a predetermined time increment in response to operation of the input element by a user.

25. The apparatus of claim 19, wherein the input element comprises a plurality of buttons, each button being operable for incrementing the timer in a predetermined time increment by a user, each button operable from outside of the housing.

26. The apparatus of claim 19, wherein the input element comprises:
a first button operable for incrementing the timer in one hour increments; and
a second button operable for incrementing the timer in one minute increments, each first and second buttons operable from outside of the housing.

27. The apparatus of claim 19, wherein the input element comprises:
a first button operable for incrementing the timer in one hour increments; and
a second button operable for incrementing the timer in 15 minute increments, each first and second buttons operable from outside of the housing.

28. The apparatus of claim 19, wherein the coupler is adapted to accept an element suitable for coupling the housing to a piece of luggage.

29. The apparatus of claim 19, wherein the housing includes a peripheral edge, the light source comprising one or more light emitting diodes arranged about the peripheral edge.

30. The apparatus of claim 19, wherein the housing includes a first broad surface and a second broad surface opposite the first broad surface, the light source comprising one or more electroluminescent panels arranged about the first and/or second broad surfaces.

31. The apparatus of claim 19, wherein the controller is operable to receive user data so as to produce a predetermined pattern of illumination if activated.

32. The apparatus of claim 19, wherein the light unit is operable to receive user data so as to produce light of a predetermined color if activated.

33. The apparatus of claim 19, wherein the housing has a relatively flat profile in the shape of a luggage tag.

34. The apparatus of claim 33, wherein the housing comprises a first broad surface and a second broad surface opposite the first broad surface defining a peripheral edge, wherein the light source is operable to illuminate at least a portion of the peripheral edge and/or at least one of the first and second broad surfaces.

35. The apparatus of claim 33, wherein the housing further comprises a card receiving member adapted to receive an identification card or the like.

36. The apparatus of claim 19, wherein the housing is in the form of a luggage handle.

37. The apparatus of claim 36, wherein at least a portion of the housing comprises translucent material, the light source including one or more light emitting diodes operable to affect illumination through the translucent material so as to be seen external to the housing.

38. A method comprising:
coupling a luggage tag to a piece of luggage, the luggage tag comprising a timer and a light source, the timer operable to illuminate the light source at a predetermined time; and
programming the timer to illuminate the light source at a predetermined time.

39. The method of claim 38, further comprising:
turning the system electronics on by activating an input element;
programming a set time to illuminate the light source; and
programming a desired lighting response of the light source.

40. The method of claim 39, wherein programming the timer to illuminate the light source at a predetermined time comprises programming the timer to illuminate the light source at a time substantially that associated with the expected time of pickup of the luggage at a destination.
